(19) United States
(12) Patent Application Publication
(10) Pub. No.: US 2016/0100451 A1
(43) Pub. Date: Apr. 7, 2016

(54) EXTENDED REDIRECT

(71) Applicant: TELEFONAKTIEBOLAGET L M ERICSSON (PUBL), Stockholm (SE)

(72) Inventors: Mikael WASS, Satila (SE); Peter RAMLE, Molnlycke (SE); Paul SCHLIWA-BERTLING, Ljungsbro (SE)

(73) Assignee: Telefonaktiebolaget L M Ericsson (publ), Stockholm (SE)

(21) Appl. No.: 14/891,739

(22) PCT Filed: May 16, 2014
(86) PCT No.: PCT/EP2014/060099

§ 371 Date: Nov. 17, 2015

Related U.S. Application Data
(60) Provisional application No. 61/824,669, filed on May 17, 2013.

(30) Foreign Application Priority Data
Aug. 27, 2013 (EP) PCT/EP2013/067740

(51) Int. Cl. H04W 76/02; H04W 8/10; H04W 48/02

(52) U.S. Cl. CPC H04W 76/027; H04W 48/02; H04W 8/10

(57) ABSTRACT

Disclosed herein is a method in a radio access network, RAN, node (315) and corresponding method in a core network node (302), for handling roaming rejection in a shared RAN (305), wherein the shared RAN is second CN (301b), the method comprising: forwarding (403), to a core network, CN, node (302) in the first CN (301a) sharing the RAN (305), a request message of a roaming wireless device (308); receiving (404) a reject message from the CN node, wherein the reject message comprises a cause of the rejection and an indicator indicating that the cause qualifies for redirection of the wireless device; determining (405), based on the indicator in the reject message, that the wireless device should be redirected to another CN node (304) in the second CN (301b) sharing the RAN (305); transmitting (406) the request message of the roaming wireless device (308) to the other CN node (304).

### TECHNICAL FIELD

Embodiments herein relate generally to redirection in a shared network.

### BACKGROUND

In a typical communications network a wireless device, communicates via a Radio Access Network (RAN) to one or more Core Networks (CNs). The communications network may also be referred to as e.g. a wireless communications network, a wireless communications system, a communications network, a communications system, a network or a system.

The wireless device may be a device by which a subscriber may access services offered by an operator's wireless network and services outside the operator's network to which the operator's radio access network and core network provide access, e.g. access to the

Internet. The wireless device may be any device, mobile or stationary, enabled to communicate over a radio channel in the wireless network, for instance but not limited to e.g. user equipment (UE), mobile phone, smart phone, sensors, meters, vehicles, household appliances, medical appliances, media players, cameras, Machine to Machine (M2M) device or any type of consumer electronic, for instance but not limited to television, radio, lighting arrangements, tablet computer, laptop or Personal Computer (PC). The wireless device may be portable, pocket storable, hand held, computer comprised, or vehicle mounted devices, enabled to communicate voice and/or data, via the radio access network, with another entity, such as another device or a server. The wireless device may also be referred to as a user equipment (UE) or a terminal.

The radio access network covers a geographical area which may be divided into cell areas, with each cell area being served by a base station. The base station may be referred to as a Radio Base Station (RBS), evolved NodeB (eNB), NodeB, B node, Radio Network Controller (RNC), Base Station Controller (BSC), Base Transceiver Station (BTS) depending on the technology and terminology used. A cell is a geographical area where radio coverage is provided by the base station at a base station site. The base station communicates over the air interface operating on radio frequencies with the wireless device(s) within range of the base station.

Network sharing allows different core network operators to connect to a shared radio access network. The core network operators do not only share the radio network elements, but may also share the radio resources themselves. In contrast, a non-shared network is a Public Land Mobile Network (PLMN) comprising a radio access network and core network, by which only one serving operator provides services to its subscriber. Subscribers of other operators may receive services by national or international roaming. A core network operator may provide services to subscribers as one of multiple serving operators that share at least a radio access network. Each core network operator may provide services to subscribers of other operators by national or international roaming. Network sharing is an agreement between the operators and is transparent to the device.

There are two different architectures for network sharing: GateWay Core Network (GWCN) as illustrated in FIG. 1a and Multi-Operator Core Network (MOCN) as illustrated in FIG. 1b. GWCN is a network sharing configuration in which parts of the core network (MSC/SGSNs) are also shared, and MOCN is a network sharing configuration in which only the RAN is shared. MSC is short for Mobile Switching Center and SGSN is short for Serving General packet radio service Support Node.

Operators using shared network deployments are impacted by roaming agreements where the roaming partners use a mechanism that share the load of their wireless devices roaming into the networks of their roaming partners, a.k.a. Roaming Steering. The mechanism that is used is to trigger a reject with cause code #17 if the roaming partner (home operator) wishes to steer the wireless device away from the operator to which the device currently attempts connectivity. The device behavior is then to search for another network. This mechanism works in a non-shared radio network where each operator runs its own radio network. In the case of a shared network deployment, the wireless device will not attempt connectivity to another operator in the shared network, but will completely move away from the shared radio network and search for another operator, leading to missed revenue for the operators sharing network. This problem arises when the wireless device is a non-supporting UE. A non-supporting UE always use the common PLMN, and both operators use the common PLMN. A common PLMN is a PLMN-id indicated in the system broadcast information as defined for conventional networks, which non-supporting UEs understand as the serving operator.

A wireless device may be a “supporting UE” or a “non-supporting UE”. According to the 3GPP, a supporting UE is a wireless device that supports network sharing in the sense that it is able to select a core network operator as the serving operator within a shared network. In other specifications, the term “network sharing supporting UE” may be used. A non-supporting UE is a wireless device that does not support network sharing in the sense that it ignores the additional broadcast system information that is specific for network sharing. In other specifications, the term “network sharing non-supporting UE” may be used.

The cause code #17 mentioned above, is one of several cause codes which the network may send to the wireless device. Cause code #17 indicates a network failure. This cause code may be sent from the network to the wireless device if the MSC/SGSN cannot serve a request from the wireless device because of a failure in some part of the PLMN. Other examples of cause codes #11-15 which indicates that a PLMN is not allowed, that the Location Area is not allowed, that Roaming is not allowed in this location area, that GPRS services are not allowed in this PLMN and that No Suitable Cells In Location Area, respectively. Cause code #9 indicates “MS identity cannot be derived by the network” which indicates that the network the UE has tried to access is not able to derive the identity of the UE. Cause code #22 indicates “Congestion” and is a cause code which is sent if the service request cannot be actioned because of congestion.

The primary task in a MOCN is the selection of a serving CN operator. In a Long Term Evolution (LTE) network, this simply means that a serving operator needs to be selected for the wireless device in the Packet Switched (PS) domain. In Global System for Mobil Communications (GSM) and Wideband Code Division Multiple Access (WCDMA) networks, however, it needs to be ensured that the same serving operator is selected for the wireless device in both the Circuit Switched (CS) and the PS domain, i.e. CS/PS coordination. CS/PS coordination may be described as a method for coordinating the registration of a wireless device in CS and PS domains of a MOCN or GWCN shared network. CS/PS coordination is achieved when the same operator is simultaneously serving the wireless device in both the CS domain and the PS domain.

A wireless device may be in different modes, such as idle mode, connected mode etc. When the wireless device is in idle mode, it performs procedures such as PLMN selection, cell selection and reselection and location registration.

At Idle mode mobility selection of a serving CN operator is done either
Directly by the wireless device if the wireless device is a “supporting UE” and if the RAN plus the CN also supports “supporting UEs”; or
Indirectly by using the MOCN redirection function in the RAN and CN if the wireless device is a “non-supporting UE” or if the RAN plus the CN does not support “supporting UEs”.

In some cases, the SGSN rejects an Attach or RAU attempt and initiates a routing procedure where the wireless device is rerouted to another core network. This scenario can occur for roaming subscribers for whom roaming is not allowed.

The purpose of rerouting is to allow these subscribers a new access attempt to another core network operator in the shared network, which they may be allowed to access. Only if the Attach or RAU is rejected with Cause Code # 11-15, the SGSN will initiate the rerouting procedure as it is only the so called Roaming Restriction Cause Codes # 11-15 that qualifies for redirection. To ensure CS/PS coordination, Roaming Restrictions shall be configured similarly in the CS and PS domains.

FIG. 2 illustrates an example scenario of redirection in a MOON due to roaming restriction. A wireless device (e.g. a UE) belongs to operator X and roams into a MOON network of CN operator 1 and CN operator 2, with which operator X has a roaming agreement or similar.

### Step 201

The wireless device transmits a Routing Area Update (RAU) request to the Radio Network Controller (RNC) in the RAN shared between CN operator 1 and CN operator 2. Instead of a RAU request, an attach request may be transmitted.

### Step 202

The RNC selects a SGSN, i.e. SGSN_1 belonging to CN operator 1.

### Step 203

The RNC forwards the RAU request to the SGSN_1.

### Step 204

The SGSN_1 sends a RAU Reject back to the RNC due to a roaming restriction. The RAU Reject message comprises a Radio Access Network Application Part (RANAP) Redirection Indication.

### Step 205

After having received the RAU Reject from the SGSN_1, the RNC selects a new CN operator, i.e. CN operator 2. Since the RAU is rejected with Cause Code # 11-15, the SGSN initiates the rerouting procedure as it is only the so called Roaming Restriction Cause Codes # 11-15 that qualifies for redirection in this example.

### Step 206

The RNC sends the RAU request to the SGSN_2 belonging to CN operator 2.

### Step 207

The SGSN_2 sends a RAU Accept to the RNC. The RAU Accept comprises a RANAP Redirection Completed indication.

### Step 208

The RNC sends a RAU Accept to the wireless device.

In a scenario where a wireless device belonging to operator X is roaming into a MOON network of CN operator 1 and CN operator 2, as exemplified in FIG. 2, operator X may want to control the distribution of operator X's subscribers between operator 1 and 2. Wanted distribution may be based on roaming agreements between the operators or due to other commercial aspects. It is therefore not always possible to handle this through configuration of Roaming Restrictions. Also configuration of Roaming Restriction is not in the control of the home operator of the wireless device. For roaming in a non-shared network, home operators achieve this by letting their Home location register (HLR) (or a special server in front of the HLR) reject a portion of the wireless device, typically with cause code # 17 (Network failure), thus informing the wireless device to search for another PLMN (i.e. another roaming partner). The decision to reject is among other things based upon the address of the CN node making the Update Location towards the HLR. For a shared network and a non-supporting UE this is not possible as both roaming partners (the sharing CN operators 1 and 2 in the example of FIG. 2) are using the same PLMN (the Common PLMN for non-supporting UEs), and a reject with cause code #17 will trigger the wireless device to search for another PLMN different from the shared network.

To only use Cause Codes # 11-15 as qualifiers for redirection prevents a roaming wireless device to get service within the shared network in situations where there is a problem at one of the sharing operators but not at the other operator. This may be valid at RAU reject with Cause Code #9 due to lack of interface between old serving CN nodes and the CN nodes of one of the sharing operators. Also Cause Codes #22, congestion, may be confined to only one of the sharing operators.

### SUMMARY

An objective of embodiments herein is therefore to obviate at least one of the above disadvantages and to provide an improved redirection procedure.

The Redirection procedure is extended with an indicator and the list of Cause Codes that qualifies for redirection by the RAN is also extended. This indicator shall then only be used by the CN nodes when it is certain that the same reject will be applied in both the CS and PS domain, otherwise there is a risk of not getting CS/PS coordinated.

Some objectives of the present solution have been accomplished by methods and nodes as follows:

A method in a CN node of a first CN for handling roaming rejections in a shared RAN, wherein the shared RAN is shared amongst the first CN and at least a second CN.

The method comprises:
receiving from a RAN node in the shared RAN a request message of a roaming wireless device;
determining that the request should be rejected;
determining a cause of the rejection;
determining that the rejection should lead to a redirection of the wireless device;
creating an indicator indicating that the cause of the rejection should lead to a redirection of the request message of the wireless device; and
transmitting a reject message to the RAN node, which reject message comprises the cause of the rejection and the indicator.

A method in a RAN node for handling roaming rejections in a shared RAN, wherein the shared RAN is shared amongst a first CN and at least a second CN. The method comprises:
forwarding, to a CN node in the first CN sharing the RAN, a request message of a roaming wireless device;
receiving a reject message from the CN node, wherein the reject message comprises a cause of the rejection and an indicator indicating that the cause qualifies for redirection of the wireless device;
determining, based on the indicator in the reject message, that the wireless device should be redirected to another CN node in the second CN sharing the RAN;
transmitting the request message of the roaming wireless device to the other CN node.

A CN node for handling roaming rejections in a shared RAN, wherein the shared RAN is shared amongst a first CN and at least a second CN.

The CN node is configured to operatively:
receive from a RAN node in the shared RAN a request message of a roaming wireless device;
determine that the request should be rejected;
determine a cause of the rejection;
determine that the rejection should lead to a redirection of the wireless device;
create an indicator indicating that the cause of the rejection should lead to a redirection of the request message of the wireless device; and
transmit a reject message to the RAN node, which reject message comprises the cause of the rejection and the indicator.

A RAN node for handling roaming rejections in a shared RAN, wherein the shared RAN is shared amongst a first CN and at least a second CN, and wherein the RAN node is configured to operatively:
forward, to a CN node in the first CN sharing the RAN, a request message of a roaming wireless device;
receive a reject message from the CN node, wherein the reject message comprises a cause of the rejection and an indicator indicating that the cause qualifies for redirection of the wireless device;
determining, based on the indicator in the reject message, that the wireless device should be redirected to another CN node in the second CN sharing the RAN;
transmit the request message of the roaming wireless device to the other CN node.

Generally:

The request message may be a RAU request or an attach request.

The cause of the rejection may be a roaming restriction in the shared network.

The indicator may be an information element.

The CN node may be a MSC or SGSN etc.

The CN node may forward the request message to a HLR of the wireless device's home operator.

The CN node may receive a reject message comprising the cause from the HLR.

The cause may be CC#17 indicating a network failure.

The RAN node may be a RNC, BSC etc.

Embodiments herein afford many advantages, of which a non-exhaustive list of examples follows:

The embodiments herein provide the advantage that it may be possible for an operator to control the distribution of its subscribers when the subscriber roams in a shared network.

Another advantage of the embodiments herein is that they may increase the success rate for the wireless device when roaming in to a MOCN and not encountering problem in all of the sharing operators CN nodes.

The new indicator does not reach the wireless device, which provides an advantage of not having to perform any new implementation in the wireless device.

Operators using shared network deployments are impacted by roaming agreements where the roaming partners use a mechanism that distribute the load of their devices roaming into the shared network between the operators of the shared network. The mechanism that is used is to trigger a reject, preferably with cause code #17, if the roaming partner (home operator) wishes to steer the device away from the operator to which a device currently attempts connectivity. As a response to a redirect, the device will then attempt connectivity to another operator in the shared network and thereby staying within the shared network, which may lead to increased revenue for the operators sharing network.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail in the following detailed description by reference to the appended drawings illustrating the embodiments and in which:

FIG. 1a is a schematic block diagram illustrating embodiments of a GWCN network.

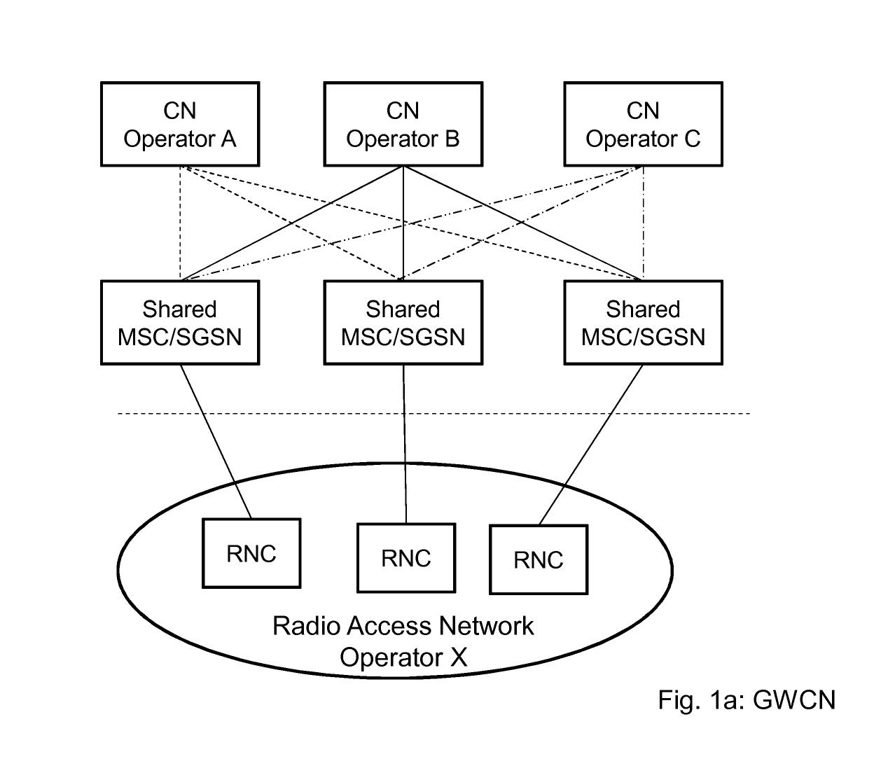

FIG. 1b is a schematic block diagram illustrating embodiments of a MOCN network.

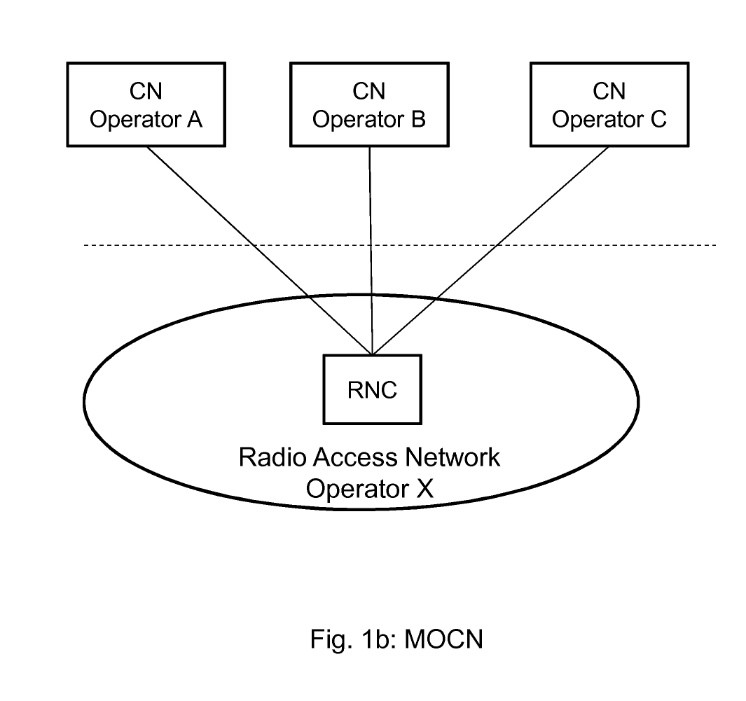

FIG. 2 is a schematic block diagram illustrating embodiments of redirection in a MOCN network due to roaming restrictions.

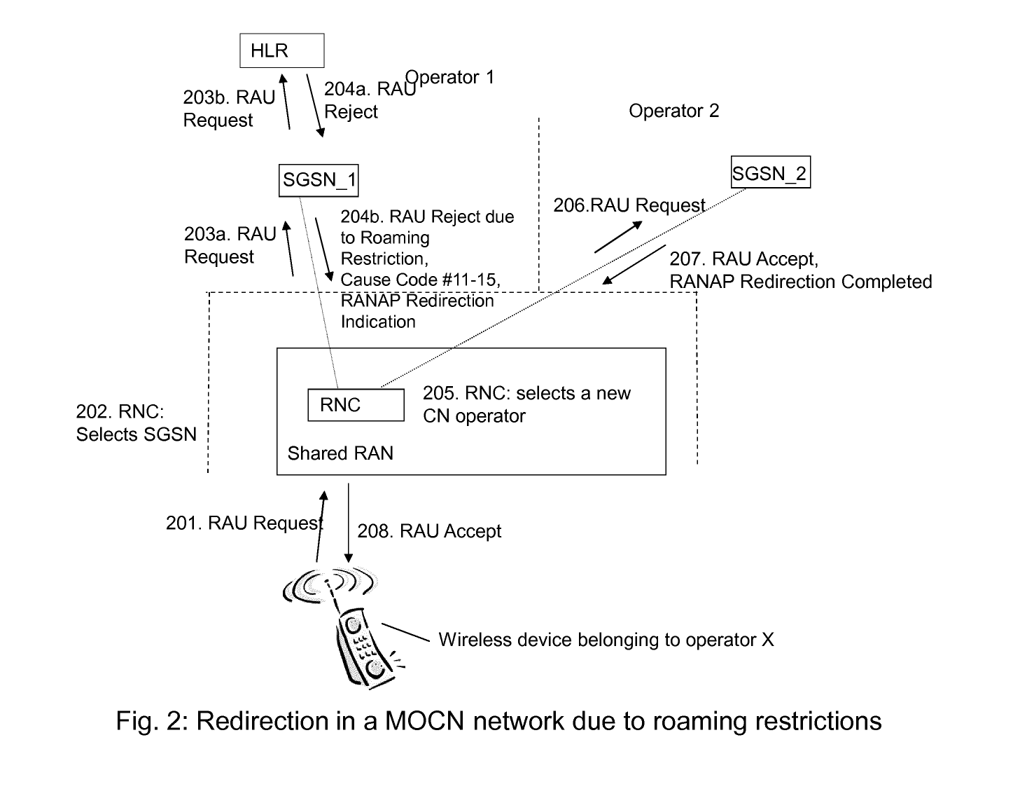

FIG. 3 is a schematic block diagram illustrating embodiments of a communications network.

FIG. 4a is a signaling diagram illustrating embodiments of a method in a communications network comprising a radio access network node (RAN node) in the form of a RNC.

FIG. 4b is a signaling diagram illustrating embodiments of a method in a communications network comprising a radio access network node (RAN node) in the form of a BSC.

FIG. 5 is a block diagram illustrating embodiments of a CN operator a.

FIG. 6 is a block diagram illustrating embodiments of a RAN_ab.

The drawings are not necessarily to scale and the dimensions of certain features may have been exaggerated for the sake of clarity. Emphasis is instead placed upon illustrating the principle of the embodiments herein.

### DETAILED DESCRIPTION

Embodiments herein ensure that wireless devices are kept among the operators sharing network that is under control of these operators, which is commercially valuable for current and future network sharing operators.

The Redirection procedure is extended with an indicator and a set of Cause Codes that qualifies for redirection by the RAN. This will make it backwards compatible and does not impose any changes in the HLRs (or front servers). It is preferred that this indicator is only be used by the CN nodes when it is certain that the same reject will be applied in both the CS and PS domain, otherwise there is a risk of not getting CS/PS coordinated. This is a reason why it may not be enough to simply extend the list of Cause Codes that qualifies for redirect.

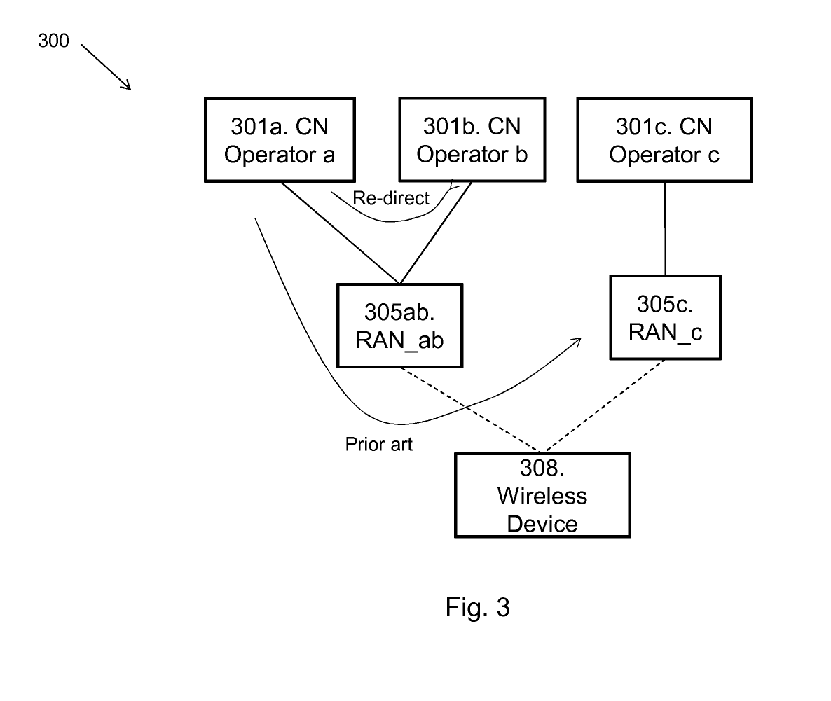

FIG. 3 depicts a communications network 300 in which embodiments herein may be implemented. The communications network 300 may in some embodiments apply to one or more radio access technologies such as for example Wideband Code Division Multiple Access (WCDMA), Global System for Mobile Communications (GSM), or any other Third Generation Partnership Project (3GPP) radio access technology, or other radio access technologies such as WiFi and WLAN, and any other network handling non-supporting UEs.

The communications network 300 comprises a shared network which is shared amongst two operators, i.e. operator a and operator b. Note that there may be more than two sharing operators, e.g. up to 6 for GSM and up to 8 for WCDMA, but two operators are used as an example in FIG. 3 for the sake of simplicity. Each of the operators has their respective core network, i.e. CN operator a 301a and CN operator b 301b. The communications network 300 comprises a third operator c having its own core network indicated as CN operator c 301c in FIG. 3. The CN operator a 301a and CN operator b 301b share a RAN_ab 305ab and the CN operator c 301c has its own RAN_{—c 305}c. The communications network 300 comprises a wireless device 308 which is operable to be connected to one of the operators.

The core networks of the three operators may comprise a network node such as an MSC and/or an SGSN. The radio access networks of the three operators may be represented by e.g. a base station, an RNC, a BSC or any other network unit capable to communicate over a radio carrier with the wireless device 308.

The wireless device 308 may be a device by which a subscriber may access services offered by an operator's network and services outside operator's network to which the operators radio access network and core network provide access, e.g. access to the Internet. The wireless device 308 may be any device, mobile or stationary, enabled to communicate over a radio channel in the communications network, for instance but not limited to e.g. user equipment, mobile phone, smart phone, sensors, meters, vehicles, household appliances, medical appliances, media players, cameras, Machine to Machine (M2M) device or any type of consumer electronic, for instance but not limited to television, radio, lighting arrangements, tablet computer, laptop or Personal Computer (PC). The wireless device 308 may be portable, pocket storable, hand held, computer comprised, or vehicle mounted devices, enabled to communicate voice and/or data, via the radio access network, with another entity, such as another wireless device or a server. The wireless device 308 may also be referred to as a user equipment or a terminal.

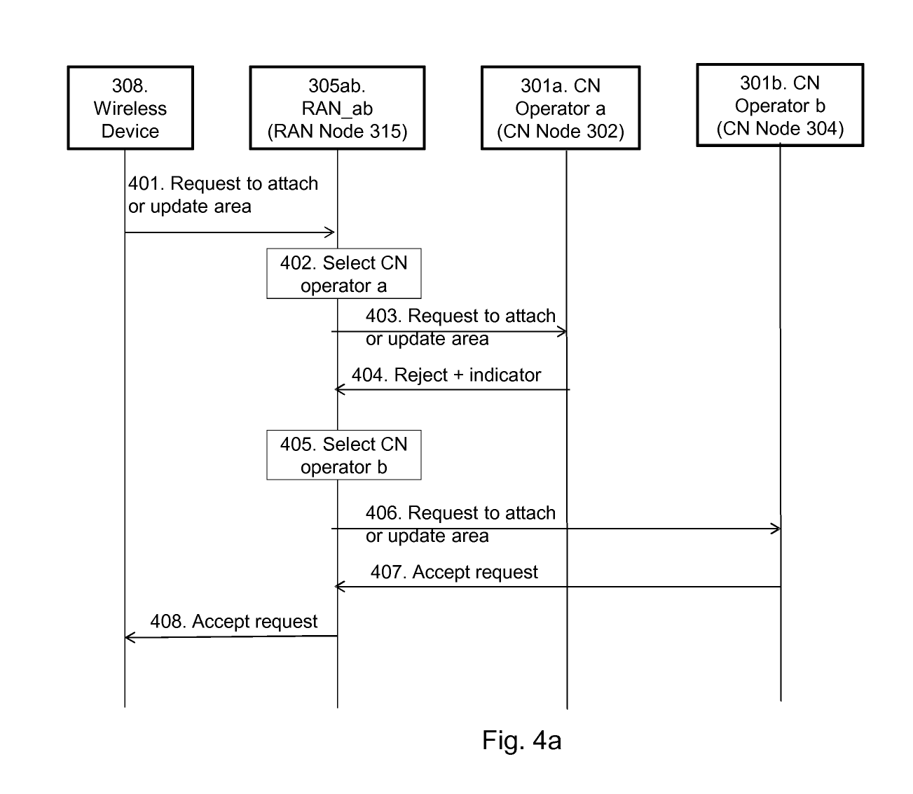

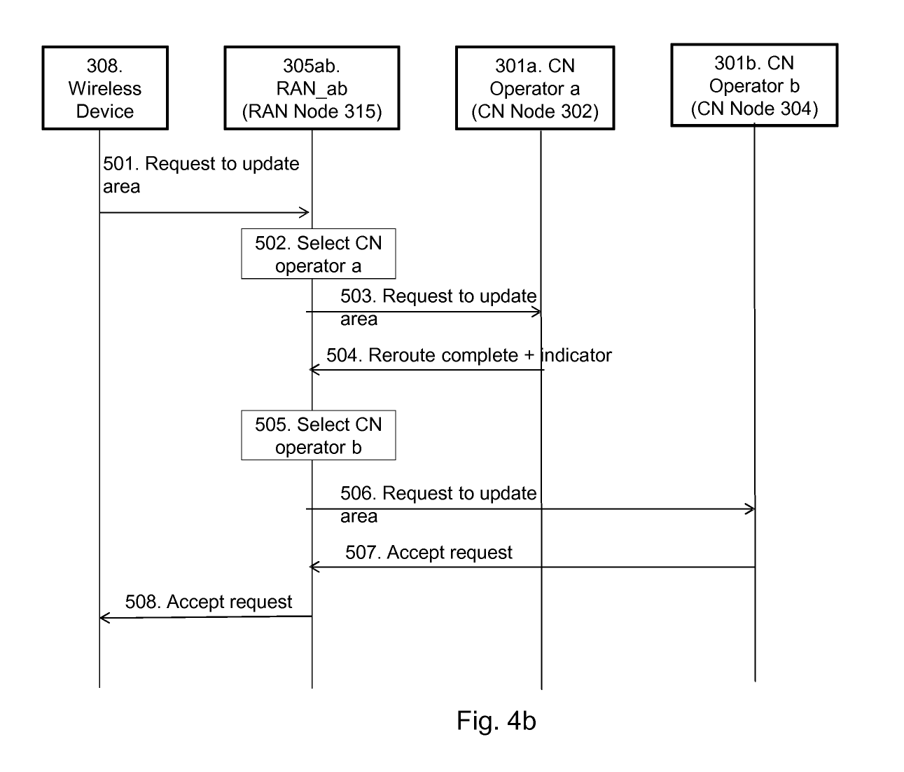

A method for redirecting the wireless device 308 in a shared network according to some embodiments will now be described with reference to the signaling diagram depicted in FIG. 4a. The method comprises the following steps, which steps may as well be carried out in another suitable order than described below.

### Step 401

The wireless device 308 enters into the shared network RAN_ab 305ab and sends a request to attach or to perform an area update to the RAN_ab 305ab. The request may be e.g. a attach request or a RAU request. It is preferred that the request is sent to a RAN node 315 of the shared network RAN_ab 305ab. Here, it is preferred that the RAN node 315 is a RNC.

### Step 402

The RAN node 315 receives the request and selects a CN operator—i.e. CN operator a 301a in this case—as a response to the received request.

### Step 403

The RAN node 315 forwards the request from the wireless device 308 to a core network node CN node 302 in the selected CN operator 301a. Here it is preferred that the CN node 302 is a SGSN or a MSC.

### Step 404

The selected CN operator a 301a rejects the request and sends a reject message from the CN node 302 to the RAN node 315.

The reject message is due to a response from the home operator HLR (not shown) of the CN operator c 301c. The response is a reaction to the request forwarded to the CN node 302 in step 403, which in turn caused the CN node 302 to request information from the home operator HLR of the wireless device 308, the response may be a reject. The reject may also be based on local conditions in the selected operator network.

The reject message comprises a cause code indicating the cause of the rejection and an extended redirection indicator indicating that the cause code qualifies for a redirection of the request and the wireless device 308. For example, considering that the cause code is CC #17 which indicates a network failure. CC #17 does not qualify for redirection according to the current standard. However, since the embodiments herein uses the extended redirection indicator indicating that the cause code qualifies for a redirection, CC#17 could still qualify for redirection. Other cause codes which previously have not qualified for redirection may also be used.

For example, the reject message may be very similar to or an extension of the Direct Transfer message shown in section 9.1.34 of the 3GPP specification TS 25.413, also see below. Here comprising the additional Information Element (IE) “Extended Redirection”, preferably indicating that the cause code in question qualifies for a redirection of the request and the wireless device 308.

| | | | IE type and | | | Assigned |
|---|---|---|---|---|---|---|
| IE/Group Name | Presence | Range | reference | Semantics description | Criticality | Criticality |
| Message Type | M | | 9.2.1.1 | | YES | ignore |
| NAS-PDU | M | | 9.2.3.5 | | YES | ignore |
| LAI | O | | 9.2.3.6 | | YES | ignore |
| RAC | O | | 9.2.3.7 | | YES | ignore |
| SAI | O | | 9.2.3.9 | | YES | ignore |
| SAPI | O | | 9.2.3.8 | | YES | ignore |
| Redirection | C | | 9.2.3.36 | | YES | ignore |
| Indication | | | | | | |
| Extended | C | | 9.2.3.XX | | YES | ignore |
| Redirection | | | | | | |
| Redirection | O | | 9.2.3.35 | | YES | ignore |
| Completed | | | | | | |
| Subscriber Profile ID | O | | 9.2.1.86 | | YES | ignore |
| for RAT/Frequency | | | | | | |
| priority | | | | | | |
| L-GW Transport | O | | Transport | Indicating the Transport | YES | ignore |
| Layer Address | | | Layer | Layer address of the L- | | |
| | | | Address | GW if the L-GW is co- | | |
| | | | 9.2.2.1 | located with RNC. It | | |
| | | | | can only be transmitted | | |
| | | | | from the RNC to the | | |
| | | | | CN. | | |

Redirection in GSM for the PC domain shall be handled in the same or similar way as now described for UTRAN etc. Redirection in GSM for the CS domain will be elaborated in some detail below with reference to FIG. 7.

### Step 405

Because of the extended redirection indicator, the RAN node 315 understands that it should redirect the wireless device 308 to another operator in the shared network. Therefore, the RAN node 315 selects the other CN operator b 305b instead.

In other words, the RAN node 315 is configured to operatively redirect the wireless device 308 to another operator in the shared network based on the redirection indicator in the reject message.

### Step 406

The RAN node 315 forwards the request to attach message or request to update area message from step 401 to a core network node CN node 304 in the other selected CN operator b 305b.

In other words, the RAN node 315 is configured to operatively forward the request from step 401 to a core network node CN node 304 in the other selected CN operator b 305b. The other CN node 304 may be of the same or similar kind as the CN node 302 mentioned above.

### Step 407

The CN node 304 accepts the request and sends a response to indicate the accept to the RAN node 315.

### Step 408

The RAN node 315 forwards the accept message to the wireless device 308.

Another method for redirecting the wireless device 308 in a shared network according to some embodiments will now be described with reference to the signaling diagram depicted in FIG. 4b. The method comprises the following steps, which steps may as well be carried out in another suitable order than described below.

Here it should be explained that redirection in GSM for the CS domain needs to be handled somewhat differently, as the REROUTE INDICATION and the REROUTE COMPLETE are two separate messages. At rejection due to any suitable redirect qualifying Cause Codes (eg Cause Code #17 or #22) a legacy BSC needs to receive the REROUTE COMPLETE message. At the same time an upgraded BSC needs to receive an indication about redirection and also the Cause Code causing the redirection. This indication must be optional so that it can be ignored by a legacy BSC. To achieve this, the REROUTE COMPLETE message is preferably used, but at the same time it should include an optional Redirection Indication together with the qualifying Cause Code. In the Base Station System Management Application Part (BSSMAP) message REROUTE COMPLETE add an optional IE similar to the Extended Redirection Indication (only including CC#17 or 25). A legacy BSC would ignore that IE and act as in a legacy system, while a rel 11 BSC shall interpret a REROUTE COMPLETE message with the new IE as a cause for redirection of the wireless device.

### Step 501

The wireless device 308 enters into the shared network RAN_ab 305ab and sends a request to perform an area update to the RAN_ab 305ab. The request may be e.g. a RAU request or similar. It is preferred that the request is sent to a RAN node 315 of the shared network RAN_ab 305ab. Here, it is preferred that the RAN node 315 is a BSC.

### Step 502

The RAN node 315 receives the request and selects a CN operator—i.e. CN operator a 301a in this case—as a response to the received request.

### Step 503

The RAN node 315 forwards the request from the wireless device 308 to a core network node CN node 302 in the selected CN operator 301a. Here it is preferred that the CN node 302 is a MSC.

### Step 504

The selected CN operator a 301a rejects the request and sends a reject message in the form of a Reroute Complete message from the CN node 302 to the RAN node 315.

The reject message is due to a response from the home operator HLR (not shown) of the CN operator c 301c. The response is in turn a reaction to the request forwarded to the CN node 302 in step 503, which causes the CN node 302 to requests information from the home operator HLR of the wireless device 308, the response may be a reject. The reject may also be based on local conditions in the selected operator network.

The reject message comprises a cause code indicating the cause of the rejection and an extended redirection indicator indicating that the cause code qualifies for a redirection of the request and the wireless device 308. For example, considering that the cause code is CC #17 which indicates a network failure. CC #17 does not qualify for redirection according to the current standard. However, since the embodiments herein uses the extended redirection indicator indicating that the cause code qualifies for a redirection, CC#17 could still qualify for redirection. Other cause codes which previously have not qualified for redirection may also be used.

For example, the rejection message may be very similar to or an extension of the Reroute Complete message shown in section 3.2.1.90 of the 3GPP specification TS 48.008, see below. The Reroute Complete message below comprises the additional Information Element (IE) “Additional Reroute Complete Outcome”, preferably indicating that the cause code in question qualifies for a redirection of the request and the wireless device 308, preferably in the same or similar manner as the Extended Redirection mentioned above.

| INFORMATION | | | | |
|---|---|---|---|---|
| ELEMENT | REFERENCE | DIRECTION | TYPE | LEN |
| Message Type | 3.2.2.1 | MSC-BSS | M | 1 |
| Reroute complete | 3.2.2.114 | MSC-BSS | M | 2 |
| outcome | | | | |
| Additional Reroute | 3.2.2.x | MSC-BSS | O | 2 |
| complete outcome | | | | |

### Step 505

Because of the extended redirection indicator, the RAN node 315 understands that it should redirect the wireless device 308 to another operator in the shared network. Therefore, the RAN node 315 selects the other CN operator b 305b instead.

In other words, the RAN node 315 is configured to operatively redirect the wireless device 308 to another operator in the shared network based on the redirection indicator in the reject message.

### Step 506

The RAN node 315 forwards the request to update area message from step 501 to a core network node CN node 304 in the other selected CN operator b 305b.

In other words, the RAN node 315 is configured to operatively forward the request from step 501 to a core network node CN node 304 in the other selected CN operator b 305b. Here it is preferred that the other CN node 304 is a MSC.

### Step 507

The CN node 304 accepts the request and sends a response to indicate the accept to the RAN node 315.

### Step 508

The RAN node 315 forwards the accept message to the wireless device 308.

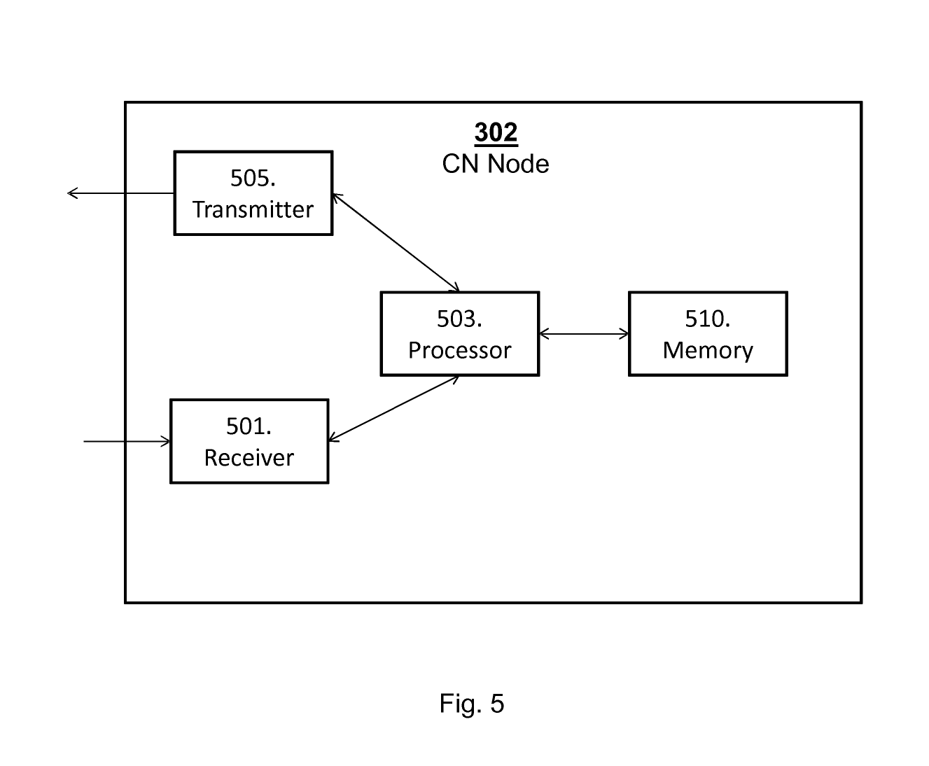

To perform the method steps shown in FIGS. 4a and 4b the CN operator a 301a comprises a CN node 302 as shown in FIG. 5. The CN node 302 comprises a receiver 501 adapted to receive a request message from the RAN node 315, such as e.g. a RAU request or an attach request message. The CN node 302 comprises a processor 503 which is adapted to interpret the received message, determine that the message should be rejected, create a reject message and the indicator which qualifies the cause code of the reject for a redirection. The CN node 302 further comprises a transmitter 505 adapted to transmit the reject message to the RAN node 315. The CN node 302 comprises a memory 510 comprising one or more memory units. The memory 510 is arranged to be used to store data, received data streams, power level measurements, messages, indicators, cause codes, threshold values, time periods, configurations, schedulings, and applications to perform the methods herein when being executed in the CN node 302.

Those skilled in the art will also appreciate that the receiver 501 and the transmitter 505 described above may refer to a combination of analog and digital circuits, and/or one or more processors configured with software and/or firmware, e.g. stored in a memory, that when executed by the one or more processors such as the processor 503 perform as described above.

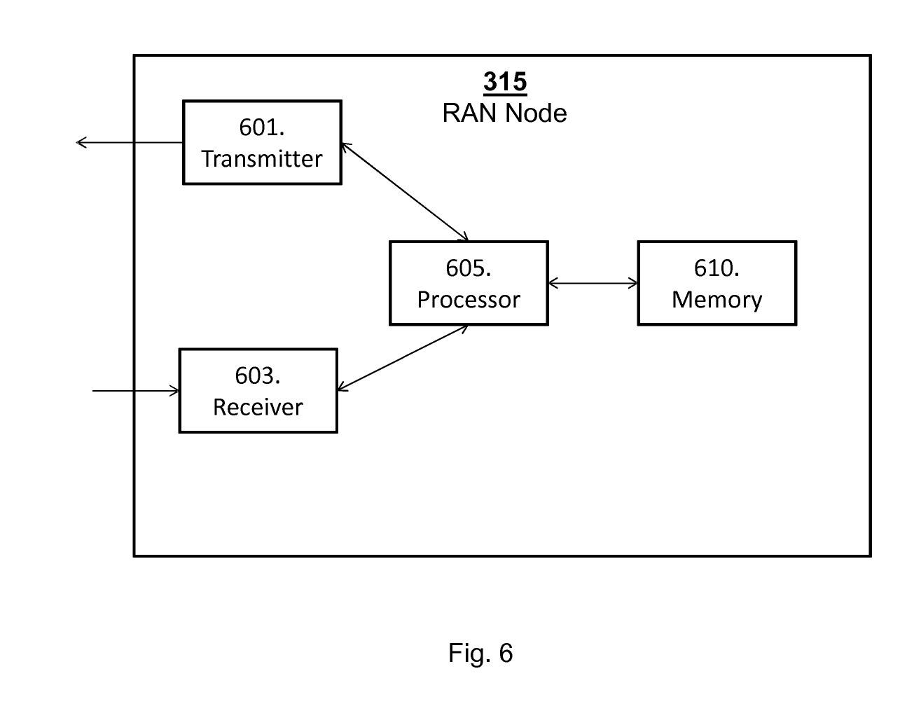

To perform the method steps shown in FIGS. 4a and 4b the RAN_ab 305ab comprises an RAN node 315 as shown in FIG. 6. The RAN node 315 comprises a transmitter 601 adapted to transmit a request message to the CN node 302, such as e.g. a RAU request or an attach request message. The RAN node 315 further comprises a receiver 603 adapted to receive a reject message from the CN node 302 comprising an indicator which qualifies the cause of the rejection for redirection. The RAN node 315 comprises a processor 605 which is adapted to interpret the received message and the indicator, determine that a redirection should be performed and thereby select another CN operator b in the shared network. The RAN node 315 comprises a memory 610 comprising one or more memory units. The memory 610 is arranged to be used to store data, received data streams, power level measurements, messages, indicators, cause codes, threshold values, time periods, configurations, schedulings, and applications to perform the methods herein when being executed in the RAN node 315.

Those skilled in the art will also appreciate that the receiver 603 and the transmitter 601 described above may refer to a combination of analog and digital circuits, and/or one or more processors configured with software and/or firmware, e.g. stored in a memory, that when executed by the one or more processors such as the processor 610 perform as described above.

The methods described above may be implemented through one or more processors, such as a processor 503 in the arrangement depicted in FIG. 5 and a processor 610 in the arrangement depicted in FIG. 6, together with computer program code for performing the functions of the embodiments herein. The processor may be for example a Digital Signal Processor (DSP), Application Specific Integrated Circuit (ASIC) processor, Field-programmable gate array (FPGA) processor or microprocessor. The program code mentioned above may also be provided as a computer program product, for instance in the form of a data carrier carrying computer program code for performing the embodiments herein when being loaded into the CN operator a 301a and/or the RAN_ab 305ab. One such carrier may be in the form of a CD ROM disc. It is however feasible with other data carriers such as a memory stick. The computer program code can furthermore be provided as pure program code on a server and downloaded to the CN operator a 301a and/or the RAN_ab 305ab.

The embodiments herein are not limited to the above described embodiments. Various alternatives, modifications and equivalents may be used. Therefore, the above embodiments should not be taken as limiting the scope of the embodiments.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

It should also be emphasized that the steps of the methods defined in the appended claims may, without departing from the embodiments herein, be performed in another order than the order in which they appear.

1. A method in a core network (CN) node of a first CN for handling roaming rejections in a shared radio access network (RAN), wherein the shared RAN is shared amongst the first CN and at least a second CN, the method comprising:
receiving from a RAN node in the shared RAN a request message of a roaming wireless device;
determining that the request should be rejected;
determining a cause of the rejection;
determining that the rejection should lead to a redirection of the wireless device ;
creating an indicator indicating that the cause of the rejection should lead to a redirection of the request message of the wireless device; and
transmitting a reject message to the RAN node, which reject message comprises the cause of the rejection and the indicator.

2. The method of claim 1, wherein: the request message is a RAU request or an attach request.

3. The method of claim 1, wherein: the cause of the rejection is a roaming restriction in the shared network.

4. The method of claim 1, wherein: the indicator is an information element.

5. The method of claim 1, wherein: the CN node is a MSC or SGSN.

6. The method of claim 1, wherein: the CN node forwards the request message to a HLR of the wireless device's home operator.

7. The method of claim 1, wherein: the CN node creates the indication by receiving a reject message comprising the cause from a HLR.

8. A method in a radio access network (RAN) node for handling roaming rejections in a shared RAN, wherein the shared RAN is shared amongst a first core network (CN) and at least a second CN, the method comprising:
forwarding, to a CN node in the first CN sharing the RAN, a request message of a roaming wireless device:
receiving a reject message from the CN node, wherein the reject message comprises a cause of the rejection and an indicator indicating that the cause qualifies for redirection of the wireless device;
determining, based on the indicator in the reject message, that the wireless device should be redirected to another CN node in the second CN sharing the RAN; and
transmitting the request message of the roaming wireless device to the other CN node.

9. The method of claim 8, wherein the RAN node is a RNC or a BSC.

10. A core network (CN) node for handling roaming rejections in a shared radio access network (RAN), wherein the shared RAN is shared amongst a first CN and at least a second CN, and wherein the CN node is configured to operatively:
receive from a radio access network, RAN node in the shared RAN a request message of a roaming wireless device;
determine that the request should be rejected;
determine a cause of the rejection;
determine that the rejection should lead to a redirection of the wireless device;
create an indicator indicating that the cause of the rejection should lead to a redirection of the request message of the wireless device; and
transmit a reject message to the RAN node, which reject message comprises the cause of the rejection and the indicator.

11. The CN node of claim 10, wherein:
the request message is a RAU request or an attach request.

12. The CN node of claim 10, wherein: the cause of the rejection is a roaming restriction in the shared network.

13. The CN node of claim 10, wherein: the indicator is an information element.

14. The CN node of claim 10, wherein: the CN node is a MSC or SGSN.

15. The CN node of claim 10, wherein: the CN node is configured to forward the request message to a HLR of the wireless device's home operator.

16. The CN node of claim 10, wherein: the CN node is configured to create the indication by receiving a reject message comprising the cause from a HLR.

17. A radio access network (RAN) node for handling roaming rejections in a shared RAN, wherein the shared RAN is shared amongst a first core network (CN) and at least a second CN, and wherein the RAN node is configured to:
forward, to a CN in the first CN sharing the RAN, a request message of a roaming wireless device;
receive a reject message from the CN node, wherein the reject message comprises a cause of the rejection and an indicator indicating that the cause qualifies for redirection of the wireless device;
determining, based on the indicator in the reject message, that the wireless device should be redirected to another CN node in the second CN sharing the RAN;
transmit the request message of the roaming wireless device to the other CN node.

18. The RAN node of claim 17, wherein the RAN node is an RNC or a BSC.
